(19) United States
(12) Patent Application Publication
(10) Pub. No.: US 2011/0311860 A1
(43) Pub. Date: Dec. 22, 2011

(54) NONAQUEOUS ELECTROLYTE BATTERY AND NONAQUEOUS ELECTROLYTE

(75) Inventors: Ichiro Yamada, Fukushima (JP); Tadahiko Kubota, Kanagawa (JP)

(73) Assignee: SONY CORPORATION, Tokyo (JP)

(21) Appl. No.: 13/156,642

(22) Filed: Jun. 9, 2011

(30) Foreign Application Priority Data
Jun. 17, 2010 (JP) P2010-138775

(51) Int. Cl. H01M 10/056; H01M 2/02

(52) U.S. Cl. 429/163; 429/324

(57) ABSTRACT

A nonaqueous electrolyte battery includes: a positive electrode; a negative electrode; and a nonaqueous electrolyte containing a solvent and an electrolyte salt, wherein the nonaqueous electrolyte contains a silyl compound represented by the following formula (1)

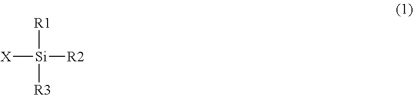

wherein X represents an aliphatic hydrocarbon group having a main chain with a carbon number of 8 or more and not more than 22; a part or all of hydrogens of X may be substituted with a halogen; each of R1 to R3 independently represents a hydrogen group, a halogen group or an aliphatic hydrocarbon group; and at least one of R1 to R3 contains a halogen group.

### CROSS REFERENCES TO RELATED APPLICATIONS

The present application claims priority to Japanese Priority Patent Application JP 2010-138775 filed in the Japan Patent Office on Jun. 17, 2010, the entire contents of which is hereby incorporated by reference.

### BACKGROUND

The present application relates to a nonaqueous electrolyte battery and a nonaqueous electrolyte. In more detail, the present application relates to a nonaqueous electrolyte battery using a nonaqueous electrolyte containing a solvent and an electrolyte salt.

In recent years, portable electronic appliances such as a camera-integrated VTR (video tape recorder), a mobile phone and a laptop personal computer have widely spread, and it is strongly demanded to realize downsizing, weight reduction and long life thereof. Following this, the development of batteries as a power source, in particular, secondary batteries which are lightweight and from which a high energy density is obtainable is advanced.

Above all, a lithium ion secondary battery is a secondary battery utilizing intercalation and deintercalation of lithium (Li) for a charge/discharge reaction and is largely expected because a high energy density is obtainable as compared with lead batteries and nickel-cadmium batteries.

In general, the lithium ion secondary battery uses, as a positive electrode active material, a metal oxide such as LiCoO₂ and, as a negative electrode active material, a carbonaceous material. Also, the lithium ion secondary battery is provided with a separator disposed between a positive electrode and a negative electrode and a nonaqueous electrolytic solution containing a solvent and a lithium salt dissolved in this solvent, such as LiPF₆. This nonaqueous electrolytic solution plays a role to move a lithium ion between the positive electrode and the negative electrode.

In general, aprotic high-dielectric constant solvents such as ethylene carbonate (EC) and propylene carbonate (PC) and aprotic low-viscosity solvents such as diethyl carbonate (DEC) and dimethyl carbonate (DMC) are used as the solvent.

A mixed solvent obtained by mixing such an aprotic high-dielectric constant solvent and such an aprotic low-viscosity solvent is mainly used. This mixed solvent is a polar solvent having such a degree that it is able to effectively dissolve an electrolyte salt therein and to cause ionic dissociation and at the same time, is an aprotic solvent capable of transmitting an ion at a sufficiently fast speed at the time of charge/discharge.

In many cases, the nonaqueous electrolytic solution having a lithium salt dissolved in such a mixed solvent of a high-dielectric constant solvent and a low-viscosity solvent exhibits high viscosity and surface tension due to interaction by polarity. In consequence, the nonaqueous electrolytic solution of the lithium ion secondary battery exhibits only low affinity with electrode materials containing a binder such as polyvinylidene fluoride (PVdF), and therefore, its penetration rate into electrode active materials or the like is low. This matter means that it takes a considerable long time for penetrating the electrolytic solution into electrode active materials or the like at a stage of assembling a battery, causing to disturb an enhancement of productivity. Also, it may be impossible to allow the electrode active material into which the electrolytic solution has not been penetrated to participate in charge/discharge. Therefore, it may be impossible to sufficiently exhibit the capacity which the electrode has.

There is proposed a method for contriving to improve penetration properties of a nonaqueous electrolytic solution into electrode active materials or the like, thereby optimizing productivity and battery characteristics. Patent Document 1 (JP-A-7-263027) proposes the addition of a surfactant to a negative electrode made of a carbon material or a nonaqueous electrolytic solution. Patent Document 2 (JP-T-2009-526349) proposes the addition of a surfactant to a cathode containing a lithium transition metal compound and/or an anode containing graphitized carbon.

General cationic, anionic, ampholytic or nonionic surfactants and fluorine based surfactants having a fluorocarbon chain have a large surface tension-lowering action and are able to enhance contact properties with electrode materials. In Patent Documents 1 and 2, general surfactants such as nonion type fluorine based surfactants (perfluoroalkyl esters) and perfluoroalkylsulfonates and a PEO-PPO block copolymer are used.

### SUMMARY

However, the surfactants used in Patent Documents 1 and 2 are inferior in resistance to oxidation-reduction to aprotic solvents, and therefore, when such a surfactant is contained in an electrolytic solution, it is problematic that the battery characteristics are deteriorated in the long-term use.

Thus, it is desirable to provide a nonaqueous electrolyte battery and a nonaqueous electrolyte, each of which is able to contrive to improve penetration properties of a nonaqueous electrolytic solution into electrode active materials or the like, to enhance productivity and battery capacity and to improve battery characteristics at the time of use over a long period of time and under a severe environment at a high temperature or the like.

An embodiment is directed to a nonaqueous electrolyte battery including a positive electrode, a negative electrode and a nonaqueous electrolyte containing a solvent and an electrolyte salt, wherein the nonaqueous electrolyte contains a silyl compound represented by the following formula (1).

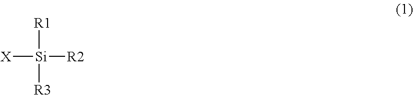

In the formula (1), X represents an aliphatic hydrocarbon group having a main chain with a carbon number of 8 or more and not more than 22;

a part or all of hydrogens of X may be substituted with a halogen;

each of R1 to R3 independently represents a hydrogen group, a halogen group or an aliphatic hydrocarbon group; and

at least one of R1 to R3 contains a halogen group.

Another embodiment is directed to a nonaqueous electrolyte containing a solvent, an electrolyte salt and a silyl compound represented by the following formula (1).

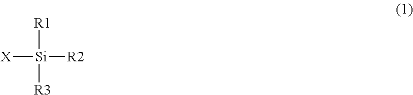

In the formula (1), X represents an aliphatic hydrocarbon group having a main chain with a carbon number of 8 or more and not more than 22;

a part or all of hydrogens of X may be substituted with a halogen;

each of R1 to R3 independently represents a hydrogen group, a halogen group or an aliphatic hydrocarbon group; and

at least one of R1 to R3 contains a halogen group.

In the embodiments, the silyl compound represented by the formula (1) is contained in the nonaqueous electrolyte. According to this, penetration properties of the nonaqueous electrolytic solution into electrode active materials or the like are improved, whereby productivity and battery capacity can be enhanced. Also, a stable coating which is called an SEI (solid electrolyte interface coating) is formed on the negative electrode at the time of charge/discharge at the beginning of use, whereby the battery characteristics at the time of use over a long period of time and under an environment at a high temperature or the like can be improved.

According to the embodiments, not only the productivity and battery capacity can be enhanced, but the battery characteristics at the time of use over a long period of time and under a severe environment at a high temperature or the like can be improved.

Additional features and advantages are described herein, and will be apparent from the following Detailed Description and the figures.

### BRIEF DESCRIPTION OF THE FIGURES

FIG. 1 is a sectional view showing a configuration example of a nonaqueous electrolyte battery according to an embodiment.

FIG. 2 is a sectional view showing enlargedly a part of a wound electrode body in FIG. 1.

FIG. 3 is an exploded perspective view showing a configuration example of a nonaqueous electrolyte battery according to an embodiment.

FIG. 4 is a sectional view along an I-I line of a wound electrode body in FIG. 3.

FIG. 5 is an exploded perspective view showing an example of a configuration of a nonaqueous electrolyte battery according to an embodiment.

FIG. 6 is a perspective view showing an example of an appearance of a battery device.

FIG. 7 is a sectional view showing an example of a configuration of a battery device.

FIG. 8 is a plan view showing an example of a shape of a positive electrode.

FIG. 9 is a plan view showing an example of a shape of a negative electrode.

FIG. 10 is a plan view showing an example of a shape of a separator.

FIG. 11 is a sectional view showing an example of a configuration of a battery device which is used for a nonaqueous electrolyte battery according an embodiment.

### DETAILED DESCRIPTION

Embodiments of the present application will be described below in detail with reference to the drawings.

1. First embodiment (a first example of a nonaqueous electrolyte battery)

2. Second embodiment (a second example of a nonaqueous electrolyte battery)

3. Third embodiment (a third example of a nonaqueous electrolyte battery)

4. Fourth embodiment (a fourth example of a nonaqueous electrolyte battery)

5. Fifth embodiment (a fifth example of a nonaqueous electrolyte battery)

6. Other embodiments (modification examples)

### 1. First Embodiment

Configuration of Nonaqueous Electrolyte Battery

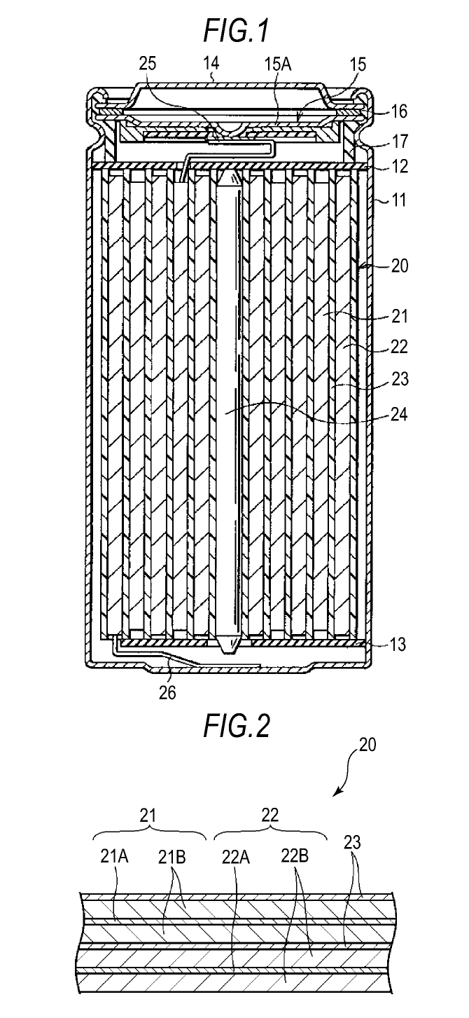

A nonaqueous electrolyte battery according to a first embodiment is described. FIG. 1 shows a sectional configuration of the nonaqueous electrolyte battery according to the first embodiment. FIG. 2 shows enlargedly a part of a wound electrode body 20 shown in FIG. 1. This nonaqueous electrolyte battery is, for example, a lithium ion secondary battery in which a capacity of a negative electrode is expressed on the basis of intercalation and deintercalation of lithium that is an electrode reactant.

In this nonaqueous electrolyte battery, a wound electrode body 20 in which a positive electrode 21 and a negative electrode 22 are laminated via a separator 23 and wound and a pair of insulating plates 12 and 13 are housed mainly in the inside of a substantially hollow columnar battery can 11. A battery structure using this columnar battery can 11 is called a cylindrical type.

The battery can 11 is constituted of, for example, iron (Fe) plated with nickel (Ni), and one end thereof is closed, with the other end being opened. In the inside of the battery can 11, a pair of the insulating plates 12 and 13 is respectively disposed vertical to the winding peripheral face so as to interpose the wound electrode body 20 therebetween.

In the open end of the battery can 11, a battery lid 14 is installed by caulking with a safety valve mechanism 15 and a positive temperature coefficient device (PTC device) 16 provided in the inside of this battery lid 14 via a gasket 17, and the inside of the battery can 11 is hermetically sealed.

The battery lid 14 is, for example, constituted of the same material as that in the battery can 11. The safety valve mechanism 15 is electrically connected to the battery lid 14 via the positive temperature coefficient device 16. In this safety valve mechanism 15, when the internal pressure of the battery reaches a fixed value or more due to an internal short circuit or heating from the outside or the like, a disc plate 15A is reversed, whereby electrical connection between the battery lid 14 and the wound electrode body 20 is disconnected.

When the temperature rises, the positive temperature coefficient device 16 controls the current by an increase of the resistance value, thereby preventing abnormal heat generation to be caused due to a large current. The gasket 17 is, for example, constituted of an insulating material, and asphalt is coated on the surface thereof.

For example, a center pin 24 is inserted in the center of the wound electrode body 20. In the wound electrode body 20, a positive electrode lead 25 made of aluminum (Al) or the like is connected to the positive electrode 21; and a negative electrode lead 26 made of nickel (Ni) or the like is connected to the negative electrode 22. The positive electrode lead 25 is electrically connected to the battery lid 14 by means of welding to the safety valve mechanism 15; and the negative electrode lead 26 is electrically connected to the battery can 11 by means of welding.

Positive Electrode

The positive electrode 21 is, for example, one in which a positive electrode active material layer 21B is provided on the both surfaces of a positive electrode collector 21A having a pair of surfaces opposing to each other. However, the positive electrode active material layer 21B may be provided on only one surface of the positive electrode collector 21A.

The positive electrode collector 21A is, for example, constituted of a metal material such as aluminum, nickel and stainless steel.

The positive electrode active material layer 21B contains, as a positive electrode active material, one or two or more kinds of a positive electrode material capable of intercalating and deintercalating lithium and may further contain other material such as a binder and a conductive agent, if desired.

Positive Electrode Material

As the positive electrode material capable of intercalating and deintercalating lithium, for example, a lithium-containing compound is preferable. This is because a high energy density is obtainable. Examples of this lithium-containing compound include a complex oxide containing lithium and a transition metal element and a phosphate compound containing lithium and a transition metal element. Of these, a compound containing at least one member selected from the group consisting of cobalt, nickel, manganese and iron as the transition metal element is preferable. This is because a higher voltage is obtainable.

Examples of the complex oxide containing lithium and a transition metal element include a lithium cobalt complex oxide (LiₓCoO₂), a lithium nickel complex oxide (LiₓNiO₂), a lithium nickel cobalt complex oxide (LiₓNi_{1-z}Co_{z}O₂ (z<1)), a lithium nickel cobalt manganese complex oxide (LiₓNi_{(1-v-w)}CoᵥMn_{w}O₂ ((v+w)<1)), and a lithium manganese complex oxide (LiMn₂O₄) or a lithium manganese nickel complex oxide (LiMn₂₋ₜNiₜO₄ (t<2)) each having a spinel type structure. Of these, cobalt-containing complex oxides are preferable. This is because not only a high capacity is obtainable, but an excellent cycle characteristic is obtainable. Also, examples of the phosphate compound containing lithium and a transition metal element include a lithium iron phosphate compound (LiFePO₄), a lithium iron manganese phosphate compound (LiFe₁₋ᵤMnᵤPO₄ (u<1)) and LiₓFe_{1-y}M2_{y}PO₄ (wherein M2 represents at least one member selected from the group consisting of manganese (Mn), nickel (Ni), cobalt (Co), zinc (Zn) and magnesium (Mg); and x is a value falling with the range of (0.9≦x≦1.1)).

Moreover, from the viewpoint that higher electrode filling properties and cycle characteristic are obtainable, the positive electrode material capable of intercalating and deintercalating lithium may be formed as a complex particle obtained by coating the surface of a core particle composed of any one of the foregoing lithium-containing compounds by a fine particle composed of any one of other lithium-containing compounds.

Besides, examples of the positive electrode material capable of intercalating and deintercalating lithium include oxides such as titanium oxide, vanadium oxide and manganese dioxide; disulfides such as titanium disulfide and molybdenum sulfide; chalcogenides such as niobium selenide; sulfur; and conductive polymers such as polyaniline and polythiophene. As a matter of course, the positive electrode material capable of intercalating and deintercalating lithium may be other material than those described above. Also, the above-exemplified series of positive electrode materials may be a mixture of two or more kinds thereof in an arbitrary combination.

Negative Electrode

The negative electrode 22 is, for example, one in which a negative electrode active material layer 22B is provided on the both surfaces of a negative electrode collector 22A having a pair of surfaces opposing to each other. However, the negative electrode active material layer 22B may be provided on only one surface of the negative electrode collector 22A.

The negative electrode collector 22A is, for example, constituted of a metal material such as copper, nickel and stainless steel.

The negative electrode active material layer 22B contains, as a negative electrode active material, one or two or more kinds of a negative electrode material capable of intercalating and deintercalating lithium and may further contain other material such as a binder and a conductive agent, if desired. On that occasion, it is preferable that a rechargeable capacity on the negative electrode material capable of intercalating and deintercalating lithium is larger than a discharge capacity of the positive electrode. Details regarding the binder and the conductive agent are the same as those in the positive electrode.

Examples of the negative electrode material capable of intercalating and deintercalating lithium include carbon materials. Examples of such a carbon material include easily graphitized carbon, hardly graphitized carbon with a (002) plane interval of 0.37 nm or more and graphite with a (002) plane interval of not more than 0.34 nm. More specifically, there are exemplified pyrolytic carbons, cokes, vitreous carbon fibers, organic polymer compound baked materials, active carbon and carbon blacks. Of these, examples of the cokes include pitch coke, needle coke and petroleum coke. The organic polymer compound baked material as referred to herein is a material obtained through carbonization by baking a phenol resin, a furan resin or the like at an appropriate temperature. The carbon material is preferable because a change in a crystal structure following the intercalation and deintercalation of lithium is very small, and therefore, a high energy density is obtainable, an excellent cycle characteristic is obtainable, and the carbon material also functions as a conductive agent. Incidentally, the shape of the carbon material may be any of a fibrous shape, a spherical shape, a granular shape or a flaky shape.

In addition to the foregoing carbon materials, examples of the negative electrode material capable of intercalating and deintercalating lithium include a material capable of intercalating and deintercalating lithium and containing, as a constituent element, at least one member selected from the group consisting of metal elements and semi-metal elements. This is because a high energy density is obtainable. Such a negative electrode material may be a simple substance, an alloy or a compound of a metal element or a semi-metal element, or may be one having one or two or more kinds of a phase in at least a part thereof. The “alloy” as referred to herein includes, in addition to alloys composed of two or more kinds of a metal element, alloys containing one or more kinds of a metal element and one or more kinds of a semi-metal element. Also, the “alloy” may contain a non-metal element. Examples of its texture include a solid solution, a eutectic (eutectic mixture), an intermetallic compound and one in which two or more kinds thereof coexist.

Examples of the metal element or semi-metal element include a metal element or a semi-metal element capable of forming an alloy together with lithium. Specific examples thereof include magnesium (Mg), boron (B), aluminum (Al), gallium (Ga), indium (In), silicon (Si), germanium (Ge), tin (Sn), lead (Pb), bismuth (Bi), cadmium (Cd), silver (Ag), zinc (Zn), hafnium (Hf), zirconium (Zr), yttrium (Y), palladium (Pd) and platinum (Pt). Of these, at least one member selected from silicon and tin is preferable, and silicon is more preferable. This is because silicon and tin have large capability to intercalate and deintercalate lithium, so that a high energy density is obtainable.

Examples of the negative electrode material containing at least one member selected from silicon and tin include a simple substance, an alloy or a compound of silicon; a simple substance, an alloy or a compound of tin; and one having one or two or more kinds of a phase in at least a part thereof.

Examples of alloys of silicon include alloys containing, as a second constituent element other than silicon, at least one member selected from the group consisting of tin (Sn), nickel (Ni), copper (Cu), iron (Fe), cobalt (Co), manganese (Mn), zinc (Zn), indium (In), silver (Ag), titanium (Ti), germanium (Ge), bismuth (Bi), antimony (Sb) and chromium (Cr). Examples of alloys of tin include alloys containing, as a second constituent element other than tin (Sn), at least one member selected from the group consisting of silicon (Si), nickel (Ni), copper (Cu), iron (Fe), cobalt (Co), manganese (Mn), zinc (Zn), indium (In), silver (Ag), titanium (Ti), germanium (Ge), bismuth (Bi), antimony (Sb) and chromium (Cr).

Examples of compounds of tin or compounds of silicon include compounds containing oxygen (O) or carbon (C), and these compounds may further contain the foregoing second constituent element in addition to tin (Sn) or silicon (Si).

As the negative electrode material containing at least one member selected from silicon (Si) and tin (Sn), for example, a material containing tin (Sn) as a first constituent element and in addition to this tin (Sn), a second constituent element and a third constituent element is especially preferable. As a matter of course, this negative electrode material may be used together with the foregoing negative electrode material. The second constituent element is at least one member selected from the group consisting of cobalt (Co), iron (Fe), magnesium (Mg), titanium (Ti), vanadium (V), chromium (Cr), manganese (Mn), nickel (Ni), copper (Cu), zinc (Zn), gallium (Ga), zirconium (Zr), niobium (Nb), molybdenum (Mo), silver (Ag), indium (In), cerium (Ce), hafnium (Hf), tantalum (Ta), tungsten (W), bismuth (Bi) and silicon (Si) The third constituent element is at least one member selected from the group consisting of boron (B), carbon (C), aluminum (Al) and phosphorus (P). This is because when the second constituent element and the third constituent element are contained, a cycle characteristic is enhanced.

Above of all, the negative electrode material is preferably an SnCoC-containing material containing tin (Sn), cobalt (Co) and carbon (C) as constituent elements and having a content of carbon (C) in the range of 9.9% by mass or more and not more than 29.7% by mass and a proportion of cobalt (Co) to the total sum of tin (Sn) and cobalt (Co)(Co/(Sn+Co)) in the range of 30% by mass or more and not more than 70% by mass. This is because in the foregoing composition range, not only a high energy density is obtainable, but an excellent cycle characteristic is obtainable.

This SnCoC-containing material may further contain other constituent element, if desired. As other constituent element, for example, silicon (Si), iron (Fe), nickel (Ni), chromium (Cr), indium (In), niobium (Nb), germanium (Ge), titanium (Ti), molybdenum (Mo), aluminum (Al), phosphorus (P), gallium (Ga) and bismuth (Bi) are preferable. The SnCoC-containing material may contain two or more kinds of these elements. This is because a capacity characteristic or a cycle characteristic is more enhanced.

Incidentally, the SnCoC-containing material has a phase containing tin (Sn), cobalt (Co) and carbon (C), and it is preferable that this phase has a lowly crystalline or amorphous structure. Also, in the SnCoC-containing material, it is preferable that at least a part of carbons that are a constituent element is bound to a metal element or a semi-metal element that is other constituent element. This is because though it may be considered that a lowering of the cycle characteristic is caused due to aggregation or crystallization of tin (Sn) or the like, when carbon is bound to other element, such aggregation or crystallization is suppressed.

Examples of a measurement method for examining the binding state of elements include X-ray photoelectron spectroscopy (XPS). In this XPS, so far as graphite is concerned, a peak of the 1s orbit (C1s) of carbon appears at 284.5 eV in an energy-calibrated apparatus such that a peak of the 4f orbit of a gold atom (Au4f) is obtained at 84.0 eV. Also, so far as surface contamination carbon is concerned, a peak of the 1s orbit (C1s) of carbon appears at 284.8 eV. On the contrary, when a charge density of the carbon element is high, for example, when carbon is bound to a metal element or a semi-metal element, the peak of C1s appears in a lower region than 284.5 eV. That is, when a peak of a combined wave of C1s obtained regarding the SnCoC-containing material appears in a lower region than 284.5 eV, at least a part of carbons (C) contained in the SnCoC-containing material is bound to a metal element or a semi-metal element as other constituent element.

Incidentally, in the XPS measurement, for example, the peak of C1s is used for correcting the energy axis of a spectrum. In general, since surface contamination carbon exists on the surface, the peak of C1s of the surface contamination carbon is fixed at 284.8 eV, and this peak is used as an energy reference. In the XPS measurement, since a waveform of the peak of C1s is obtained as a form including the peak of the surface contamination carbon and the peak of carbon in the SnCoC-containing material, the peak of the surface contamination carbon and the peak of the carbon in the SnCoC-containing material are separated from each other by means of analysis using, for example, a commercially available software program. In the analysis of the waveform, the position of a main peak existing on the lowest binding energy side is used as an energy reference (284.8 eV).

Also, examples of the negative electrode material capable of intercalating and deintercalating lithium include metal oxides and polymer compounds, each of which is capable of intercalating and deintercalating lithium. Examples of the metal oxide include iron oxide, ruthenium oxide and molybdenum oxide; and examples of the polymer compound include polyacetylene, polyaniline and polypyrrole.

Incidentally, the negative electrode material capable of intercalating and deintercalating lithium may be other material than those described above. Also, the above-exemplified negative electrode materials may be a mixture of two or more kinds thereof in an arbitrary combination.

The negative electrode active material layer 22B may be, for example, formed by any of a vapor phase method, a liquid phase method, a spraying method, a baking method or a coating method, or a combined method of two or more kinds of these methods. When the negative electrode active material layer 22B is formed by adopting a vapor phase method, a liquid phase method, a spraying method, a baking method or a combined method of two or more kinds of these methods, it is preferable that the negative electrode active material layer 22B and the negative electrode collector 22A are alloyed on at least a part of an interface therebetween. Specifically, it is preferable that on the interface, the constituent elements of the negative electrode collector 22A are diffused into the negative electrode active material layer 22B, the constituent elements of the negative electrode active material layer 22B are diffused into the negative electrode collector 22A, or these constituent elements are mutually diffused into each other. This is because not only breakage to be caused due to expansion and shrinkage of the negative electrode active material layer 22B following the charge/discharge can be suppressed, but electron conductivity between the negative electrode active material layer 22B and the negative electrode collector 22A can be enhanced.

Incidentally, examples of the vapor phase method include a physical deposition method and a chemical deposition method, specifically a vacuum vapor deposition method, a sputtering method, an ion plating method, a laser abrasion method, a thermal chemical vapor deposition (CVD) method and a plasma chemical vapor deposition method. As the liquid phase method, known techniques such as electrolytic plating and electroless plating can be adopted. The baking method as referred to herein is, for example, a method in which after a granular negative electrode active material is mixed with a binder and the like, the mixture is dispersed in a solvent and coated, and the coated material is then heat treated at a higher temperature than a melting point of the binder or the like. As to the baking method, known techniques can be utilized, too, and examples thereof include an atmospheric baking method, a reaction baking method and a hot press baking method.

Separator

The separator 23 partitions the positive electrode 21 and the negative electrode 22 from each other and allows a lithium ion to pass therethrough while preventing a short circuit of the current to be caused due to the contact between the both electrodes. This separator 23 is constituted of, for example, a porous film made of a synthetic resin such as polytetrafluoroethylene, polypropylene and polyethylene; a porous film made of a ceramic; or the like, and a laminate of two or more kinds of these porous films may also be used. The separator 23 may be constituted of polyvinylidene fluoride, aramid, polyacrylonitrile or the like. This separator 23 is impregnated with an electrolytic solution.

Electrolytic Solution

The electrolytic solution contains a solvent, an electrolyte salt and a silyl compound represented by the formula (1).

Solvent

Examples of the solvent which can be used include ethylene carbonate (EC), propylene carbonate (PC), butylene carbonate, dimethyl carbonate, diethyl carbonate, ethyl methyl carbonate, methyl propyl carbonate, γ-butyrolactone, γ-valerolactone, 1,2-dimethoxyethane, tetrahydrofuran, 2-methyltetrahydrofuran, tetrahydropyran, 1,3-dioxolane, 4-methyl-1,3-dioxolane, 1,3-dioxane, 1,4-dioxane, methyl acetate, ethyl acetate, methyl propionate, ethyl propionate, methyl butyrate, methyl isobutyrate, methyl trimethylacetate, ethyl trimethylacetate, acetonitrile, glutaronitrile, adiponitrile, methoxyacetonitrile, 3-methoxypropionitrile, N,N-dimethylformamide, N-methylpyrrolidinone, N-methyloxazolidinone, N,N′-dim ethyl imidazolidinone, nitromethane, nitroethane, sulfolane, trimethyl phosphate and dimethyl sulfoxide. This is because in the case of using this electrolytic solution for electrochemical devices such as batteries, excellent capacity, cycle characteristic and storage characteristic are obtainable. These materials may be used singly or in admixture of plural kinds thereof.

Above all, it is preferable to use one containing, as the solvent, at least one member selected from the group consisting of ethylene carbonate, propylene carbonate, dimethyl carbonate, diethyl carbonate and ethyl methyl carbonate. This is because sufficient effects are obtainable. In that case, in particular, it is preferable to use one containing a mixture of ethylene carbonate or propylene carbonate, each of which is a high viscosity (high dielectric constant) solvent (for example, specific dielectric constant ∈≧30), and dimethyl carbonate, diethyl carbonate or ethyl methyl carbonate, each of which is a low viscosity solvent (for example, viscosity≦1 mPa·s). This is because dissociation properties of the electrolyte salt and mobility of ions are enhanced, so that higher effects are obtainable.

Electrolyte Salt

The electrolyte salt may, for example, contain one or two or more kinds of a light metal salt such as a lithium salt. Examples of this lithium salt include lithium hexafluorophosphate (LiPF₆), lithium tetrafluoroborate (LiBF₄), lithium perchlorate (LiClO₄), lithium hexafluoroarsenate (LiAsF₆), lithium tetraphenylborate (LiB(C₆H₅)₄), lithium methanesulfonate (LiCH₃SO₃), lithium trifluoromethanesulfonate (LiCF₃SO₃), lithium tetrachloroaluminate (LiAlCl₄), dilithium hexafluorosilicate (Li₂SiF₆), lithium chloride (LiCl) and lithium bromide (LiBr). Above all, at least one member selected from the group consisting of lithium hexafluorophosphate, lithium tetrafluoroborate, lithium perchlorate and lithium hexafluoroarsenate is preferable, and lithium hexafluorophosphate is more preferable. This is because the resistance of the electrolytic solution is lowered. In particular, it is preferable to use lithium tetrafluoroborate together with lithium hexafluorophosphate.

It is preferable that this electrolytic solution contains at least one member of compounds selected from the group consisting of unsaturated cyclic carbonates and halogenated cyclic carbonates. This is because the chemical stability of the electrolytic solution is more enhanced.

Examples of the unsaturated cyclic carbonate include vinylene carbonate based compounds, vinyl ethylene carbonate based compounds and methylene ethylene based carbonate based compounds. Examples of the vinylene carbonate based compound include vinylene carbonate, methyl vinylene carbonate, ethyl vinylene carbonate, 4,5-dimethyl-1,3-dioxol-2-one and 4,5-diethyl-1,3-dioxol-2-one; examples of the vinyl ethylene carbonate based compound include vinyl ethylene carbonate, 4-methyl-4-vinyl-1,3-dioxolan-2-one, 4-ethyl-4-vinyl-1,3-dioxolan-2-one, 5-methyl-4-vinyl-1,3-dioxolan-2-one and 4,5-divinyl-1,3-dioxolan-2-one; and examples of the methylene ethylene carbonate based compound include 4-methylene-1,3-dioxolan-2-one and 4,4-dimethyl-5-methylene-1,3-dioxolan-2-one. These materials may be used singly or in admixture of plural kinds thereof.

Examples of the halogenated cyclic carbonate include 4-fluoro-1,3-dioxolan-2-one, 4-chloro-1,3-dioxolan-2-one, 4,5-difluoro-1,3-dioxolan-2-one, tetrafluoro-1,3-dioxolan-2-one, 4-chloro-5-fluoro-1,3-dioxolan-2-one, 4,5-dichloro-1,3-dioxolan-2-one, tetrachloro-1,3-dioxolan-2-one, 4,5-bistrifluoromethyl-1,3-dioxolan-2-one, 4-trifluoromethyl-1,3-dioxolan-2-one, 4,5-difluoro-4,5-dimethyl-1,3-dioxolan-2-one, 4,4-difluoro-5-methyl-1,3-dioxolan-2-one, 4-ethyl-5,5-difluoro-1,3-dioxolan-2-one, 4-fluoro-5-trifluoromethyl-1,3-dioxolan-2-one, 4-methyl-5-trifluoromethyl-1,3-dioxolan-2-one, 4-fluoro-4,5-dimethyl-1,3-dioxolan-2-one, 5-(1,1-difluoroethyl)-4,4-difluoro-1,3-dioxolan-2-one, 4,5-dichloro-4,5-dimethyl-1,3-dioxolan-2-one, 4-ethyl-5-fluoro-1,3-dioxolan-2-one, 4-ethyl-4,5-difluoro-1,3-dioxolan-2-one, 4-ethyl-4,5,5-trifluoro-1,3-dioxolan-2-one and 4-fluoro-4-methyl-1,3-dioxolan-2-one. These materials may be used singly or in admixture of plural kinds thereof.

Silyl Compound Represented by the Formula (1)

The electrolytic solution contains a silyl compound represented by the following formula (1).

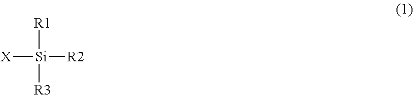

In the formula (1), X represents an aliphatic hydrocarbon group having a main chain with a carbon number of 8 or more and not more than 22;

a part or all of hydrogens of X may be substituted with a halogen;

each of R1 to R3 independently represents a hydrogen group, a halogen group or an aliphatic hydrocarbon group; and

at least one of R1 to R3 contains a halogen group.

In the formula (1), examples of the aliphatic hydrocarbon group include a saturated aliphatic hydrocarbon group and an unsaturated aliphatic hydrocarbon group. Examples of the saturated aliphatic hydrocarbon group include an alkyl group.

The silyl compound represented by the formula (1) is a surfactant. In general, in view of the fact that this surfactant has a polar segment and a non-polar segment, it exhibits affinity with a nonaqueous electrolytic solution with polarity and a non-polar electrode active material with hydrophobicity. When the silyl compound represented by the formula (1) is added to the nonaqueous electrolytic solution, the silyl compound represented by the formula (1) exists on the interface between the nonaqueous electrolytic solution and the electrode active material and takes a structure in which the polar segment is aligned in the nonaqueous electrolytic solution, and the non-polar segment is aligned in the electrode active material, respectively. As a result, the nonaqueous electrolytic solution can easily penetrate into the electrode while mediating the surfactant. In consequence, it is possible to prevent the occurrence of the matter that the electrolytic solution does not sufficiently penetrate into the electrode, whereby the amount of the electrode active material contributing to an electrochemical reaction is lowered, leading to a lowering of the capacity.

Also, when the silyl compound represented by the formula (1) in which a polar segment thereof is a halogenated silyl group is contained in the nonaqueous electrolytic solution, it may be considered that a stable coating which is called an SEI (solid electrolyte interface coating) is formed on the negative electrode due to charge/discharge at the beginning of use, whereby it becomes possible to suppress the separation of a carbonaceous material or the decomposition of a carbonate. Also, it may be considered that the silyl compound represented by the formula (1) is adsorbed on the positive electrode, too simultaneously with the formation of SEI on the negative electrode, thereby suppressing the occurrence of the matter that the lithium salt in the electrolyte and the solvent are oxidized and decomposed. When the electrolytic solution containing the silyl compound represented by the formula (1) is used, SEI formed due to the decomposition on the negative electrode contains a considerable amount of a stiff inorganic component such as a lithium halide. Also, the coating due to adsorption can be formed on the positive electrode by adsorption due to the halogenated silyl group which this silyl compound has, and therefore, it may be considered that the battery characteristics are enhanced even in the use under a high-temperature environment or the like.

In the formula (1), as for the aliphatic hydrocarbon group constituting X, as the carbon number of the main chain increases, the hydrophobicity increases, whereby the effect as the surfactant is enhanced. Thus, the carbon number of the main chain is defined to be 8 or more. Also, from the standpoint that more excellent battery characteristics under a high-temperature environment can be obtained, it is preferable that in the formula (1), the aliphatic hydrocarbon group constituting X has a carbon number of not more than 20 in terms of the main chain.

Also, in the formula (1), the halogen group contained in at least one of R1 to R3 is preferably a chlorine group or a fluorine group. Also, in the formula (1), the number of the halogen group on the silicon atom is preferably 2 or more, and more preferably 3. This is because when the number of the halogen group on the silicon atom is large, ability for forming a protective film on the electrode surface becomes high, and a stiffer and stable protective film is formed, so that the decomposition reaction of the electrolytic solution can be more suppressed.

More specifically, examples of the silyl compound represented by the formula (1) include silyl compounds such as octyltrichlorosilane, decyltrichlorosilane, dodecyl trichlorosilane, octadecyltrichlorosilane, octyltrifluorosilane, decyltrifluorosilane, dodecyltrifluorosilane, octadecyltrifluorosilane, octylmethyldichloroslane, decylmethyldichloroslane, dodecylmethyldichloroslane, octadecylmethyldichloroslane, octylmethyldifluorosilane, decylmethyldifluorosilane, dodecylmethyldifluorosilane, octadecylmethyldifluorosilane, octyldimethylchlorosilane, decyldimethylchlorosilane, dodecyldimethylchlorosilane, octadecyldimethylchlorosilane, octyldimethylfluorosilane, decyldimethylfluorosilane, dodecyldimethylfluorosilane and octadecyldimethylfluorosilane. Above all, dodecyltrichlorosilane, octadecyltrichlorosilane, dodecylmethyldichlorosilane, octadecylmethyldichlorosilane, dodecyldimethylchlorosilane and octadecyldimethylchlorosilane are preferable. This is because not only such a material is easily available, but high effects are obtainable. These additives may be used in admixture of two or more kinds thereof.

Content

For example, a content of the silyl compound represented by the formula (1) is preferably 0.01% by mass or more and not more than 1% by mass, and more preferably 0.1% by mass or more and not more than 0.5% by mass relative to the electrolytic solution. When the content of the silyl compound represented by the formula (1) is excessively small, the effect as the surfactant is not sufficient, and it may be impossible to accelerate the penetration of the electrolytic solution into the electrode active material. Also, when the content of the silyl compound represented by the formula (1) is excessively large, the coating on the electrode becomes thick, and coating resistance becomes too large, so that there is a tendency that other characteristics of the battery are deteriorated. The addition amount is preferable an amount at which the silyl compound represented by the formula (1) is consumed as SEI by the initial charge/discharge.

Manufacturing Method of Nonaqueous Electrolyte Battery

The thus configured nonaqueous electrolyte battery can be manufactured in the following manner. Incidentally, in view of the fact that the electrolytic solution containing the silyl compound represented by the formula (1) is improved in the penetration properties into the electrode, in the following manufacturing steps of the nonaqueous electrolyte battery, a time until the electrolytic solution sufficiently penetrates into the electrode can be shortened. According to this, the productivity of the battery can be enhanced.

Manufacture of Positive Electrode

First of all, the positive electrode 21 is fabricated. For example, a positive electrode material, a binder and a conductive agent are mixed to form a positive electrode mixture, which is then dispersed in an organic solvent to form a positive electrode mixture slurry in a paste form. Subsequently, the positive electrode mixture slurry is uniformly coated on the both surfaces of the positive electrode collector 21A by a doctor blade or a bar coater or the like and then dried. Finally, the coating is subjected to compression molding by a roll press or the like while heating, if desired, thereby forming the positive electrode active material layer 21B. In that case, the compression molding may be repeatedly carried out plural times.

Manufacture of Negative Electrode

Next, the negative electrode 22 is fabricated. For example, a negative electrode material and a binder and optionally, a conductive agent are mixed to form a negative electrode mixture, which is then dispersed in an organic solvent to form a negative electrode mixture slurry in a paste form. Subsequently, the negative electrode mixture slurry is uniformly coated on the both surfaces of the negative electrode collector 22A by a doctor blade or a bar coater or the like and then dried. Finally, the coating is subjected to compression molding by a roll press or the like while heating, if desired, thereby forming the negative electrode active material layer 22B.

Next, the positive electrode lead 25 is installed in the positive electrode collector 21A by means of welding or the like, and the negative electrode lead 26 is also installed in the negative electrode collector 22A by means of welding or the like. Thereafter, the positive electrode 21 and the negative electrode 22 are wound via the separator 23; a tip end of the positive electrode lead 25 is welded to the safety valve mechanism 15; and a tip end of the negative electrode lead 26 is also welded to the battery can 11. Then, the wound positive electrode 21 and negative electrode 22 are interposed between a pair of the insulating plates 12 and 13 and housed in the inside of the battery can 11. After housing the positive electrode 21 and the negative electrode 22 in the inside of the battery can 11, the electrolytic solution is injected into the inside of the battery can 21 and impregnated in the separator 23. Thereafter, the battery lid 14, the safety valve mechanism 15 and the positive temperature coefficient device 16 are fixed to the open end of the battery can 11 upon being caulked via the gasket 17. There is thus completed the nonaqueous electrolyte battery shown in FIGS. 1 and 2.

Effect

According to the first embodiment, not only the productivity and the battery capacity can be enhanced, but the battery characteristics at the time of use over a long period of time and under a severe environment at a high temperature or the like can be improved.

### 2. Second Embodiment

Configuration of Nonaqueous Electrolyte Battery

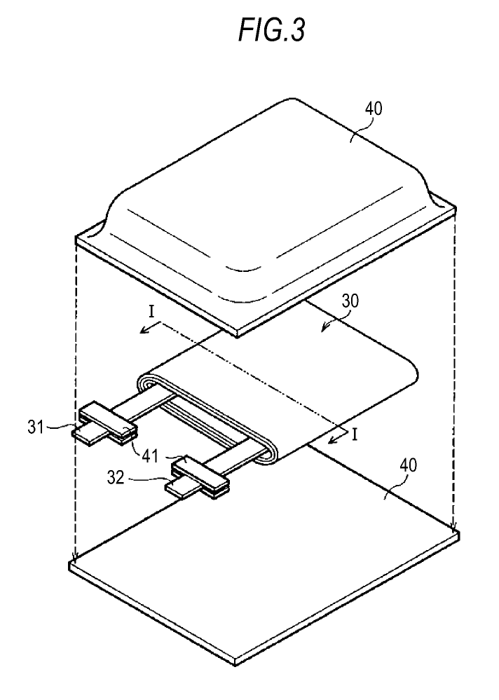

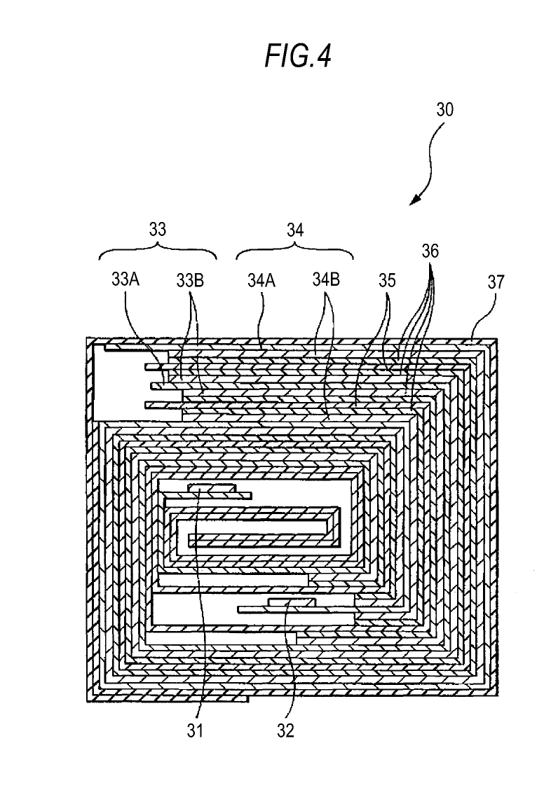

The nonaqueous electrolyte battery according to the second embodiment is described. FIG. 3 is an exploded perspective configuration of the nonaqueous electrolyte battery according to the second embodiment; and FIG. 4 shows enlargedly a section along an I-I line of a wound electrode body 30 shown in FIG. 3.

This nonaqueous electrolyte battery has a configuration in which the wound electrode body 30 having mainly a positive electrode lead 31 and a negative electrode lead 32 installed therein is housed in the inside of a film-shaped package member 40. A battery structure using this film-shaped package member 40 is called a laminated film type.

Each of the positive electrode lead 31 and the negative electrode lead 32 is, for example, led out from the inside of the package member 40 toward the outside in the same direction. The positive electrode lead 31 is, for example, constituted of a metal material such as aluminum, and the negative electrode lead 32 is, for example, constituted of a metal material such as copper, nickel and stainless steel. Such a metal material is, for example, formed in a thin plate state or a network state.

The package member 40 is, for example, constituted of an aluminum laminated film obtained by sticking a nylon film, an aluminum foil and a polyethylene film in this order. For example, this package member 40 has a structure in which respective outer edges of the two rectangular aluminum laminated films are allowed to adhere to each other by means of fusion or with an adhesive in such a manner that the polyethylene film is disposed opposing to the wound electrode body 30.

A contact film 41 is inserted between the package member 40 and each of the positive electrode lead 31 and the negative electrode lead 32 for the purpose of preventing invasion of the outside air from occurring. This contact film 41 is constituted of a material having adhesion to each of the positive electrode lead 31 and the negative electrode lead 32. Examples of such a material include polyolefin resins such as polyethylene, polypropylene, modified polyethylene and modified polypropylene.

Incidentally, the package member 40 may also be constituted of a laminated film having other lamination structure, or constituted of a polymer film such as polypropylene or a metal film, in place of the foregoing aluminum laminated film.

FIG. 4 shows a sectional configuration along an I-I line of the wound electrode body 30 shown in FIG. 3. This wound electrode body 30 is one prepared by laminating a positive electrode 33 and a negative electrode 34 via a separator 35 and an electrolyte 36 and winding the laminate, and an outermost peripheral part thereof is protected by a protective tape 37.

The positive electrode 33 is, for example, one in which a positive electrode active material layer 33B is provided on the both surfaces of a positive electrode collector 33A. The negative electrode 34 is, for example, one in which a negative electrode active material layer 34B is provided on the both surfaces of a negative electrode collector 34A, and the negative electrode active material layer 34B is disposed opposing to the positive electrode active material layer 33B. The configurations of the positive electrode collector 33A, the positive electrode active material layer 33B, the negative electrode collector 34A, the negative electrode active material layer 34B and the separator 35 are the same as those of the positive electrode collector 21A, the positive electrode active material layer 21B, the negative electrode collector 22A, the negative electrode active material layer 22B and the separator 23, respectively according to the first embodiment.

The electrolyte 36 contains the electrolytic solution according to the first embodiment and a polymer compound capable of holding this electrolytic solution therein and is an electrolyte in a so-called gel form. The electrolyte in a gel form is preferable because not only a high ion conductivity (for example, 1 mS/cm or more at room temperature) is obtainable, but liquid leakage can be prevented from occurring.

As the polymer compound, a compound which is gelled upon absorption of the electrolytic solution can be used. Examples thereof include polyacrylonitrile, polyvinylidene fluoride, a copolymer of polyvinylidene fluoride and polyhexafluoropropylene, polytetrafluoroethylene, polyhexafluoropropylene, polyethylene oxide, polypropylene oxide, polyphosphazene, polysiloxane, polyvinyl acetate, polyvinyl alcohol, polymethyl methacrylate, polyacrylic acid, polymethacrylic acid, a styrene-butadiene rubber, a nitrile-butadiene rubber, polystyrene and polycarbonate. These materials may be used singly or in admixture of plural kinds thereof. Of these, polyacrylonitrile, polyvinylidene fluoride, polyhexafluoropropylene or polyethylene oxide is preferable. This is because such a compound is electrochemically stable.

Manufacturing Method of Nonaqueous Electrolyte Battery

This nonaqueous electrolyte battery is, for example, manufactured by the following three kinds of manufacturing methods (first to third manufacturing methods).

First Manufacturing Method

In a first manufacturing method, first of all, for example, the positive electrode active material layer 33B is formed on the both surfaces of the positive electrode collector 33A to fabricate the positive electrode, and the negative electrode active material layer 34B is formed on the both surfaces of the negative electrode collector 34A to fabricate the negative electrode 34, respectively, according to the same fabrication procedures of the positive electrode 21 and the negative electrode 22 according to the first embodiment.

Subsequently, a precursor solution containing the electrolytic solution, a polymer compound and a solvent is prepared and coated on each of the positive electrode 33 and the negative electrode 34, and the solvent is then volatilized to form the electrolyte 36 in a gel form. Subsequently, the positive electrode lead 31 is installed in the positive electrode collector 33A, and the negative electrode lead 32 is also installed in the negative electrode collector 34A.

Subsequently, the positive electrode 33 and the negative electrode 34 each having the electrolyte 36 formed thereon are laminated via the separator 35, the laminate is wound in a longitudinal direction thereof, and thereafter, the protective tape 37 is allowed to adhere to an outermost peripheral part thereof, thereby fabricating the wound electrode body 30. Finally, for example, the wound electrode body 30 is interposed between the two package members 40 in a film form, and the outer edges of the package members 40 are allowed to adhere to each other by means of heat fusion or the like, thereby enclosing the wound electrode body 30 therein. On that occasion, the contact film 41 is inserted between each of the positive electrode lead 31 and the negative electrode lead 32 and the package member 40. There is thus completed the nonaqueous electrolyte battery.

Second Manufacturing Method

In a second manufacturing method, first of all, the positive electrode lead 31 is installed in the positive electrode 33, and the negative electrode lead 32 is also installed in the negative electrode 34. Subsequently, the positive electrode 33 and the negative electrode 34 are laminated via the separator 35, the laminate is wound in a longitudinal direction thereof, and thereafter, the protective tape 37 is allowed to adhere to an outermost peripheral part thereof, thereby fabricating a wound body that is a precursor of the wound electrode body 30.

Subsequently, the wound body is interposed between the two package members 40 in a film form, and the outer edges exclusive of one side are allowed to adhere to each other by heat fusion or the like, thereby housing the wound body in the inside of the package member 40 in a bag form. Subsequently, an electrolyte composition containing the electrolytic solution, a monomer that is a raw material of a polymer compound, a polymerization initiator and optionally, other material such as a polymerization inhibitor is prepared and injected into the inside of the package member 40 in a bag form, and thereafter, an opening of the package member 40 is hermetically sealed by means of heat fusion or the like. Finally, the monomer is heat polymerized to prepare a polymer compound, thereby forming the electrolyte 36 in a gel form. There is thus completed the nonaqueous electrolyte battery.

Third Manufacturing Method

In a third manufacturing method, first of all, a wound body is formed and housed in the inside of the package member 40 in a bag form in the same manner as in the foregoing second manufacturing method, except for using the separator 35 having a polymer compound coated on the both surfaces thereof.

Examples of the polymer compound which is coated on this separator 35 include polymers composed of, as a component, vinylidene fluoride, namely a homopolymer, a copolymer or a multi-component copolymer, or the like. Specific examples thereof include polyvinylidene fluoride; a binary copolymer composed of, as components, vinylidene fluoride and hexafluoropropylene; and a ternary copolymer composed of, as components, vinylidene fluoride, hexafluoropropylene and chlorotrifluoroethylene.

Incidentally, the polymer compound may contain one or two or more kinds of other polymer compounds together with the foregoing polymer composed of, as a component, vinylidene fluoride. Subsequently, the electrolytic solution is prepared and injected in the inside of the package material 40, and thereafter, an opening of the package member 40 is hermetically sealed by means of heat fusion or the like. Finally, the separator 35 is brought into intimate contact with each of the positive electrode 33 and the negative electrode 34 via the polymer compound upon heating while adding a weight to the package member 40. According to this, the electrolytic solution is impregnated into the polymer compound, and the polymer compound is gelled to form the electrolyte 36. There is thus completed the nonaqueous electrolyte battery.

Effect

According to the second embodiment, the same effects as those according to the first embodiment are brought.

### 3. Third Embodiment

A nonaqueous electrolyte battery according to a third embodiment is described. The nonaqueous electrolyte battery according to the third embodiment is the same as the nonaqueous electrolyte battery according to the second embodiment, except for using the electrolytic solution as it is in place of the material (electrolyte 36) in which the electrolytic solution is held by the polymer compound. In consequence, the configuration thereof is hereunder described centering on points which are different from those according to the second embodiment.

Configuration of Nonaqueous Electrolyte Battery

In the nonaqueous electrolyte battery according to the third embodiment, an electrolytic solution is used in place of the electrolyte 36 in a gel form. In consequence, the wound electrode body 30 has a configuration in which the electrolyte 36 is omitted, and the electrolytic solution is impregnated in the separator 35.

Manufacturing Method of Nonaqueous Electrolyte Battery

This nonaqueous electrolyte battery is, for example, manufactured in the following manner.

First of all, for example, a positive electrode active material, a binder and a conductive agent are mixed to prepare a positive electrode mixture, and this positive electrode mixture is dispersed in a solvent such as N-methyl-2-pyrrolidone to prepare a positive electrode mixture slurry. Subsequently, this positive electrode mixture slurry is coated on the both surfaces of the positive electrode collector 33A and dried, and the resultant is then compression molded to form the positive electrode active material layer 33B. There is thus fabricated the positive electrode 33. Subsequently, for example, the positive electrode lead 31 is joined with the positive electrode collector 33A by means of, for example, ultrasonic welding, spot welding or the like.

Also, for example, a negative electrode material and a binder are mixed to prepare a negative electrode mixture, which is then dispersed in a solvent such as N-methyl-2-pyrrolidone to prepare a negative electrode mixture slurry. Subsequently, this negative electrode mixture slurry is coated on the both surfaces of the negative electrode collector 34A and dried, and the resultant is then compression molded to form the negative electrode active material layer 34B. There is thus fabricated the negative electrode 34. Subsequently, for example, the negative electrode lead 32 is joined with the negative electrode collector 34A by means of, for example, ultrasonic welding, spot welding or the like.

Subsequently, the positive electrode 33 and the negative electrode 34 are wound via the separator 35; the resultant is interposed into the package member 40; and thereafter, the electrolytic solution is injected, followed by hermetically sealing the package member 40. There is thus obtained the nonaqueous electrolyte battery shown in FIGS. 3 and 4.

Effect

According to the third embodiment, the same effects as those according to the first embodiment are brought.

### 4. Fourth Embodiment

Configuration of Nonaqueous Electrolyte Battery

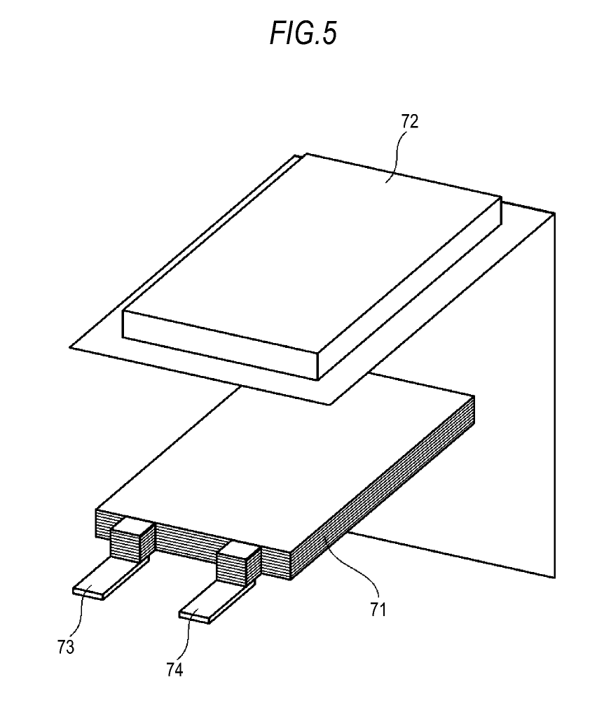

FIG. 5 is an exploded perspective view showing an example of a configuration of a nonaqueous electrolyte battery according a fourth embodiment. As shown in FIG. 5, this nonaqueous electrolyte battery is one in which a battery device 71 having a positive electrode lead 73 and a negative electrode lead 74 installed therein is housed in the inside of a package member 72 in a film form and is able to realize downsizing, weight reduction and thinning.

Each of the positive electrode lead 73 and the negative electrode lead 74 is, for example, led out from the inside of the package member 72 toward the outside in the same direction.

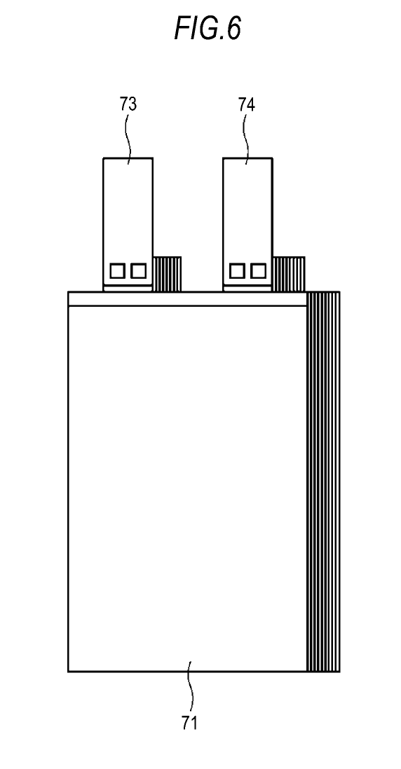

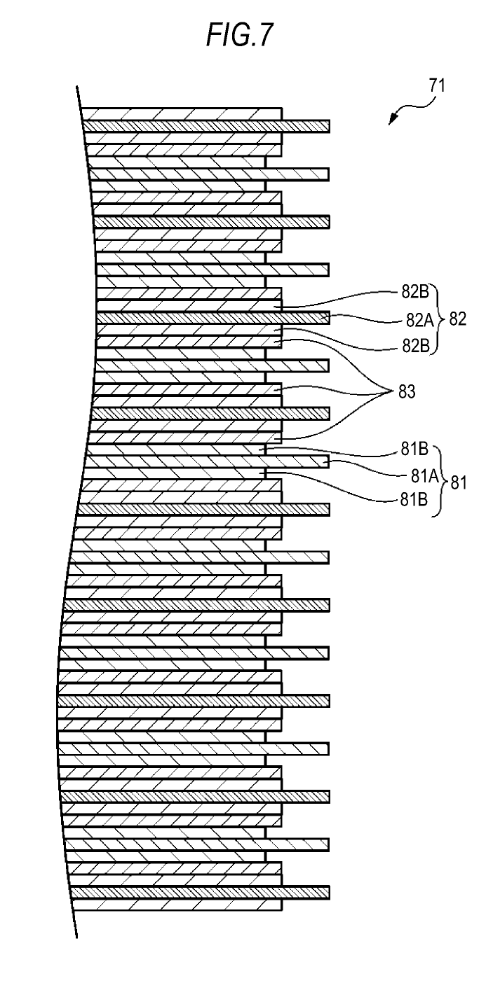

FIG. 6 is a perspective view showing an example of an appearance of the battery device 71. FIG. 7 is a sectional view showing an example of a configuration of the battery device 71. As shown in FIGS. 6 and 7, this battery device 71 is a laminated electrode body in which a positive electrode 81 and a negative electrode 82 are laminated via a separator 83, and the battery device 71 is impregnated with the electrolytic solution according to the first embodiment.

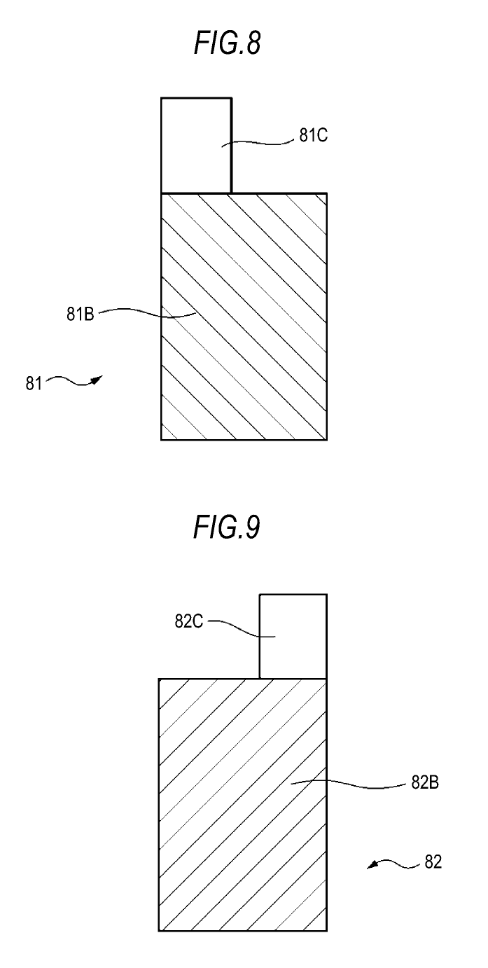

For example, the positive electrode 81 has a structure in which a positive electrode active material layer 81B is provided on the both surfaces of a positive electrode collector 81A having a pair of surfaces. As shown in FIG. 8, the positive electrode 81 has a rectangular electrode portion and a collector-exposed portion 81C extending from one side of the electrode portion. This collector-exposed portion 81C is not provided with the positive electrode active material layer 81B and is in a state where the positive electrode collector 81A is exposed. The collector-exposed portion 81C is electrically connected to the positive electrode lead 73. Incidentally, while illustration is omitted, a region where the positive electrode active material layer 81B is existent only on one surface of the positive electrode collector 81A may be provided.

For example, the negative electrode 82 has a structure in which a negative electrode active material layer 82B is provided on the both surfaces of a negative electrode collector 82A having a pair of surfaces. As shown in FIG. 9, the negative electrode 82 has a rectangular electrode portion and a collector-exposed portion 82C extending from one side of the electrode portion. This collector-exposed portion 82C is not provided with the negative electrode active material layer 82B and is in a state where the negative electrode collector 82A is exposed. The collector-exposed portion 82C is electrically connected to the negative electrode lead 74. Incidentally, while illustration is omitted, a region where the negative electrode active material layer 82B is existent only on one surface of the negative electrode collector 82A may be provided.

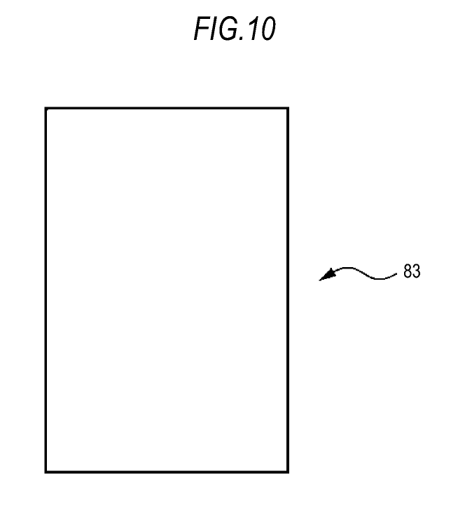

As shown in FIG. 10, the separator 83 has a shape such as a rectangular shape.

Materials constituting the positive electrode collector 81A, the positive electrode active material layer 81B, the negative electrode collector 82A, the negative electrode active material layer 82B and the separator 83 are the same as those in the positive electrode collector 21A, the positive electrode active material layer 21B, the negative electrode collector 22A, the negative electrode active material layer 22B and the separator 23, respectively according to the first embodiment.

Manufacturing Method of Nonaqueous Electrolyte Battery

The thus configured nonaqueous electrolyte battery can be, for example, manufactured in the following manner.

Fabrication of Positive Electrode

The positive electrode 81 is fabricated in the following manner. First of all, for example, a positive electrode active material, a binder and a conductive agent are mixed to prepare a positive electrode mixture, and this positive electrode mixture is dispersed in an organic solvent such as N-methylpyrrolidone to prepare a positive electrode mixture slurry in a paste form. Subsequently, the positive electrode mixture slurry is coated on the both surfaces of the positive electrode collector 81A and dried, followed by pressing to form the positive electrode active material layer 81B. Thereafter, the resultant is cut into the shape shown in FIG. 8, or the like, thereby obtaining the positive electrode 81.

Fabrication of Negative Electrode

The negative electrode 82 is fabricated in the following manner. First of all, for example, a negative electrode active material, a binder and a conductive agent are mixed to prepare a negative electrode mixture, and this negative electrode mixture is dispersed in an organic solvent such as N-methylpyrrolidone to prepare a negative electrode mixture slurry in a paste form. Subsequently, the negative electrode mixture slurry is coated on the both surfaces of the negative electrode collector 82A and dried, followed by pressing to form the negative electrode active material layer 82B. Thereafter, the resultant is cut into the shape shown in FIG. 9, or the like, thereby obtaining the negative electrode 82.

Fabrication of Battery Device

The battery device 71 is fabricated in the following manner. First of all, a polypropylene-made microporous film or the like is cut into the shape shown in FIG. 10, thereby fabricating the separator 83. Subsequently, a plural number of the thus obtained negative electrodes 82, positive electrodes 81 and separators 83 are, for example, laminated in the order of the negative electrode 82, the separator 83, the positive electrode 81, . . . , the positive electrode 81, the separator 83 and the negative electrode 82, thereby fabricating the battery device 71 as shown in FIG. 7.

Subsequently, the collector-exposed portion 81C of the positive electrode 81 is welded to the positive electrode lead 73. Similarly, the collector-exposed portion 82C of the negative electrode 82 is welded to the negative electrode lead 74. Subsequently, after impregnating the electrolytic solution in the battery device 71, the battery device 71 is interposed between the package members 72, and the outer edges of the package members 72 are allowed to adhere to each other by means of heat fusion or the like, thereby sealing the battery device 71 therein. On that occasion, each of the positive electrode lead 73 and the negative electrode lead 74 is disposed so as to come out from the package member 72 via the heat-fused part, thereby forming positive and negative electrode terminals. There is thus obtained the desired nonaqueous electrolyte battery.

Effect

The fourth embodiment has the same effects as those according to the first embodiment according to the present disclosure.

### 5. Fifth Embodiment

Next, a fifth embodiment is described. A nonaqueous electrolyte battery according to this fifth embodiment is one using an electrolyte layer in a gel form in place of the electrolytic solution in the nonaqueous electrolyte battery according to the fourth embodiment. The same portions as those in the fourth embodiment are given the same symbols, and their descriptions are omitted.

Configuration of Nonaqueous Electrolyte Battery

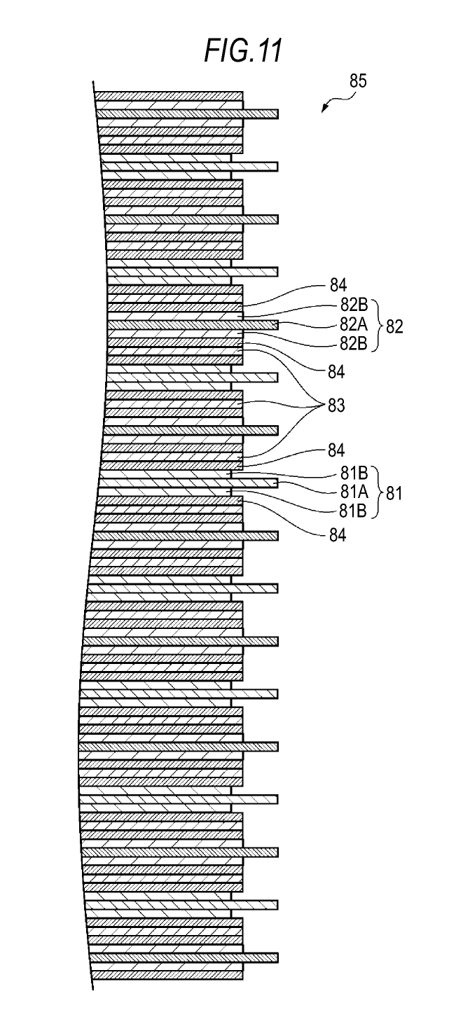

FIG. 11 is a sectional view showing an example of a configuration of a battery device to be used for the nonaqueous electrode secondary battery according to the fourth embodiment. A battery device 85 is one in which the positive electrode 81 and the negative electrode 82 are laminated via the separator 83 and an electrolyte layer 84.

The electrolyte layer 84 contains the electrolytic solution the same as that in the first embodiment and a polymer compound serving as a holding material capable of holding this electrolytic solution therein and takes a so-called gel form. The electrolyte layer 84 in a gel form is preferable because not only a high ion conductivity is obtainable, but liquid leakage of the battery can be prevented from occurring. A constitution of the polymer compound is the same as that in the nonaqueous electrolyte battery according to the fourth embodiment.

Manufacturing Method of Nonaqueous Electrolyte Battery

The thus configured nonaqueous electrolyte battery can be, for example, manufactured in the following manner.

First of all, a precursor solution containing a solvent, an electrolyte salt, a polymer compound and a mixed solvent is coated on each of the positive electrode 81 and the negative electrode 82, and the mixed solvent is then vaporized to form the electrolyte layer 84. The nonaqueous electrolyte battery can be obtained by following the same subsequent steps as those according to the fourth embodiment, except that the positive electrode 81 and the negative electrode 82 each having the electrolyte layer 84 formed thereon are used.

Effect

The fifth embodiment has the same effects as those according to the first embodiment according to the present disclosure.

### EXAMPLES

Examples of the present disclosure are specifically described below, but it should not be construed that the present disclosure is limited only to these Examples.

For the sake of convenience for the description, the following compounds are referred to as Compounds A to U, respectively.

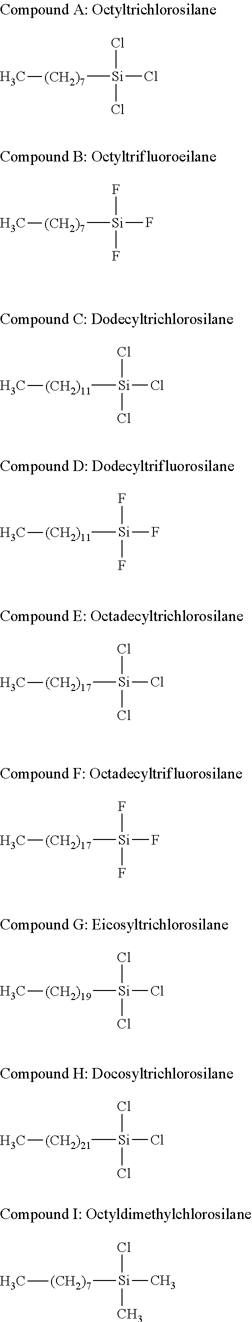

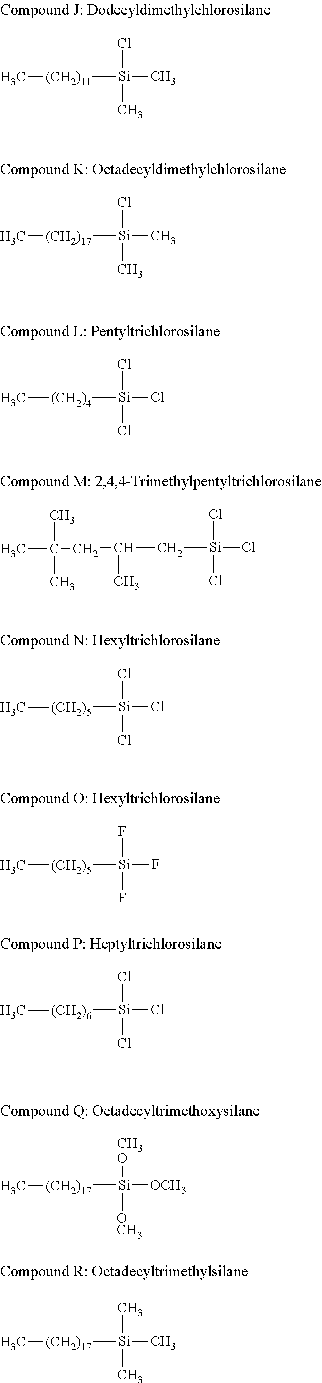

Compound S: PEG-PPG block copolymer (Pluronic-F127, manufactured by BASF AG)

F₃C—(CF₂)7SO3⁻Li⁺

Compound T: Lithium perfluorooctanesulfonate

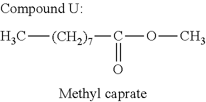

### Example 1-1

By using, as a negative electrode active material, MCMB (mesocarbon microbead) based graphite that is a carbon material, a secondary battery of a laminated film type shown in FIGS. 3 and 4 was fabricated according to the following procedures.

First of all, 94 parts by mass of lithium cobaltate (LiCoO2) as a positive electrode active material, 3 parts by mass of graphite as a conductive agent and 3 parts by mass of polyvinylidene fluoride (PVdF) as a binder were uniformly mixed, to which was then added N-methylpyrrolidone to obtain a positive electrode mixture coating solution.

Subsequently, this positive electrode mixture coating solution was uniformly coated on the both surfaces of a 10 μm-thick aluminum (Al) foil, and after drying, the resultant was compression molded to form a positive electrode active material layer having a thickness per one surface of 30 μm (volume density: 3.40 g/cc). This was cut into a shape of 50 mm in width and 300 mm in length, thereby obtaining a positive electrode.

Also, 97 parts by mass of MCMB (mesocarbon microbead) based graphite as a negative electrode active material and 3 parts by mass of PVdF as a binder were uniformly mixed, to which was then added N-methylpyrrolidone to obtain a negative electrode mixture coating solution.

Subsequently, this negative electrode mixture coating solution was uniformly coated on the both surfaces of a 10 μm-thick copper foil, and after drying, the resultant was compression molded to form a negative electrode active material layer having a thickness per one surface of 30 μm (volume density: 1.80 g/cc). This was cut into a shape of 50 mm in width and 300 mm in length, thereby obtaining a negative electrode.

As a separator, one prepared by coating polyvinylidene fluoride in a thickness of 2 μm on each surface of a 7 μm-thick microporous polyethylene film was used.

An electrolytic solution was prepared in the following manner. That is, first of all, a mixed solvent of ethylene carbonate (EC) and diethyl carbonate (DEC) in a mass ratio of 3/7 was prepared. 0.9 moles/kg of lithium hexafluorophosphate (LiPF₆) as an electrolyte salt was dissolved in this mixed solvent. 0.005% by mass of Compound A was dissolved in this solution, thereby preparing an electrolytic solution.

The positive electrode and the negative electrode were wound via the separator, and the wound body was put into a package member in a bag form made of an aluminum laminated film. Thereafter, 2 g of the electrolytic solution was injected, and the bag was then heat fused to fabricate a laminated film type battery of Example 1-1. This battery had a capacity of 800 mAh on the basis of the active material amount.

### Example 1-2

A laminated film type battery was prepared in the same manner as in Example 1-1, except that on the occasion of preparing the electrolytic solution, the concentration of Compound A was changed to 0.01% by mass.

### Example 1-3

A laminated film type battery was prepared in the same manner as in Example 1-1, except that on the occasion of preparing the electrolytic solution, the concentration of Compound A was changed to 0.5% by mass.

### Example 1-4

A laminated film type battery was prepared in the same manner as in Example 1-1, except that on the occasion of preparing the electrolytic solution, the concentration of Compound A was changed to 1% by mass.

### Example 1-5

A laminated film type battery was prepared in the same manner as in Example 1-1, except that on the occasion of preparing the electrolytic solution, the concentration of Compound A was changed to 2% by mass.

### Comparative Example 1-1

A laminated film type battery was prepared in the same manner as in Example 1-1, except that on the occasion of preparing the electrolytic solution, Compound A was not added.

### Comparative Example 1-2

A laminated film type battery was prepared in the same manner as in Example 1-1, except that on the occasion of preparing the electrolytic solution, Compound A was not added, and after the fabrication, the battery was allowed to stand for 12 hours, thereby penetrating the electrolytic solution into the electrode active material.

The batteries of Examples 1-1 to 1-5 and Comparative Examples 1-1 to 1-2 were subjected to the following high-temperature cycle test and high-temperature storage test.

Measurement of Initial Capacity and Long-Term Cycle Test

Each of the batteries was first subjected to charge/discharge of one cycle at 800 mA under an environment at 23° C., thereby determining an initial discharge capacity. Subsequently, charge/discharge of 300 cycles was repeated under an environment at 23° C., and a discharge capacity retention rate at the 300th cycle to the discharge capacity at the first cycle was determined as [{(discharge capacity at the 300th cycle)/(discharge capacity at the first cycle)}×100(%)]. As to the charge/discharge condition, the battery was subjected to constant-current constant-voltage charge at a current of 1 C to an upper limit voltage of 4.2 V, followed by subjecting to constant-current discharge at a current of 1 C to a final voltage of 3.0 V. The term “1 C” referred to herein is a current value at which a theoretical capacity is completely discharged for one hour.

Measurement of Blister at the Time of High-Temperature Storage

Each of the batteries was first subjected to charge/discharge of one cycle at 800 mA under an environment at 23° C., thereby measuring a battery thickness before storage. Subsequently, the battery was again charged for 3 hours in an atmosphere at 23° C. while setting an upper limit voltage to 4.2 V and stored in a charged state at 4.2 V in a thermostat at 85° C. for 24 hours, thereby determining a difference between the battery thickness after storage and the battery thickness before storage as a blister at the time of high-temperature storage.

Measurement of Resistance after High-Temperature Storage

After initial charge, a value (mΩ) of 1 kHz-alternating current impedance in a charged state at 4.2 V was measured. After storing in a charged state at 4.2 V in a thermostat at 85° C. for 24 hours, the same measurement was performed. A change of resistance after storage was calculated according to the following expression.

Change of resistance after storage (mΩ)=(Resistance after storage)−(Resistance at the time of initial charge

The test results are shown in the following Table 1.

TABLE 1

| | | | | | Blister at the time | Change in |
|---|---|---|---|---|---|---|
| | Surfactant | | Initial discharge | Discharge capacity | of high-temperature | resistance |
| | Kind | % by mass | capacity (mAh) | retention rate (%) | storage (mm) | value (mΩ) |
| Example 1-1 | Compound A | 0.005 | 796 | 82 | 2.06 | 31 |
| Example 1-2 | | 0.01 | 805 | 82 | 1.41 | 23 |
| Example 1-3 | | 0.5 | 806 | 82 | 1.25 | 22 |
| Example 1-4 | | 1 | 802 | 81 | 0.74 | 24 |
| Example 1-5 | | 2 | 800 | 80 | 0.38 | 30 |
| Comparative | — | — | 791 | 78 | 2.52 | 34 |
| Example 1-1 | | | | | | |
| Comparative | — | — | 802 | 79 | 2.54 | 33 |
| Example 1-2 | | | | | | |

The following are noted from Table 1. According to Examples 1-1 to 1-5, because of use of the electrolytic solution containing Compound A, a high discharge capacity was obtained. In view of the fact that the capacity of the battery is close to the capacity calculated from the active material amount, it may be considered that the electrolytic solution sufficiently penetrates into the electrode due to the effect of the surfactant (Compound A). Also, according to Examples 1-1 to 1-5, because of use of the electrolytic solution containing Compound A, the blister at the time of high-temperature storage and a rise of the resistance value were suppressed as compared with Comparative Examples 1-1 and 1-2 using the electrolytic solution not containing Compound A.

Incidentally, in Comparative Example 1-2 in which though the electrolytic solution did not contain the surfactant (Compound A), the electrolytic solution was penetrated by the step of allowing it to stand for 12 hours, a high discharge capacity was obtained as compared with Comparative Example 1-1; however, this value was still insufficient. It may be considered that this is caused due to the fact that the penetration of the electrolytic solution into the electrode is slow, so that the electrolytic solution into the electrode is not sufficient.

Also, according to Examples 1-1 to 1-5, it was noted that the content of Compound A is preferably 0.01% by mass or more and not more than 1% by mass, at which the coating by Compound A is not excessively produced. When the content of Compound A exceeded 1% by mass, though the effect for suppressing blister at the time of high-temperature storage became high, a rise of the resistance and a reduction of the discharge capacity following this were observed.

### Example 2-1

A laminated film type battery was fabricated in the same manner as in Example 1-3.

### Examples 2-2 to 2-11 and Comparative Examples 2-1 to 2-10

Laminated film type batteries were fabricated in the same manner as in Example 2-1, except that on the occasion of preparing the electrolytic solution, each of Compounds B to U was added in place of Compound A.

The laminated film type batteries of Examples 2-1 to 2-11 and Comparative Examples 2-1 to 2-10 were subjected to measurement of initial capacity, long-term cycle test, measurement of blister at the time of high-temperature storage and measurement of resistance after high-temperature storage in the same manners as in Example 1-1. The test results are shown in the following Table 2.

TABLE 2

| | | | | | Blister at the time | Change in |
|---|---|---|---|---|---|---|
| | Surfactant | | Initial discharge | Discharge capacity | of high-temperature | resistance |
| | Kind | % by mass | capacity (mAh) | retention rate (%) | storage (mm) | value (mΩ) |
| Example 2-1 | Compound A | 0.5 | 806 | 82 | 1.25 | 22 |
| Example 2-2 | Compound B | | 804 | 80 | 1.22 | 24 |
| Example 2-3 | Compound C | | 806 | 82 | 1.28 | 22 |
| Example 2-4 | Compound D | | 806 | 80 | 1.25 | 23 |
| Example 2-5 | Compound E | | 808 | 82 | 1.34 | 21 |
| Example 2-6 | Compound F | | 806 | 81 | 1.34 | 21 |
| Example 2-7 | Compound G | | 805 | 82 | 1.41 | 19 |
| Example 2-8 | Compound H | | 804 | 80 | 1.58 | 18 |
| Example 2-9 | Compound I | | 804 | 82 | 1.36 | 20 |
| Example 2-10 | Compound J | | 805 | 83 | 1.41 | 20 |
| Example 2-11 | Compound K | | 805 | 83 | 1.49 | 18 |
| Comparative | Compound L | 0.5 | 788 | 77 | 1.05 | 35 |
| Example 2-1 | | | | | | |
| Comparative | Compound M | | 788 | 79 | 1.10 | 33 |
| Example 2-2 | | | | | | |
| Comparative | Compound N | | 790 | 80 | 1.13 | 30 |
| Example 2-3 | | | | | | |
| Comparative | Compound O | | 792 | 81 | 1.14 | 29 |
| Example 2-4 | | | | | | |
| Comparative | Compound P | | 790 | 81 | 1.20 | 29 |
| Example 2-5 | | | | | | |
| Comparative | Compound Q | | 806 | 78 | 2.60 | 35 |
| Example 2-6 | | | | | | |
| Comparative | Compound R | | 790 | 79 | 2.56 | 36 |
| Example 2-7 | | | | | | |
| Comparative | Compound S | | 802 | 76 | 2.73 | 35 |
| Example 2-8 | | | | | | |
| Comparative | Compound T | | 805 | 80 | 2.55 | 32 |
| Example 2-9 | | | | | | |
| Comparative | Compound U | | 803 | 77 | 2.67 | 36 |
| Example 2-10 | | | | | | |

The following are noted from Table 2.

In the case of using an electrolytic solution containing the silylalkyl halide compound having a saturated hydrocarbon group having a main chain with a carbon number of 8 or more as in Compounds A to K, a high discharge capacity was obtained. That is, when the carbon number of the main chain of the saturated hydrocarbon group is large, the effect as the surfactant increases; and the silylalkyl halide compound having a saturated hydrocarbon group having a main chain with a carbon number of 8 or more is sufficiently large in terms of the effect as the surfactant. In the case of using an electrolytic solution containing this, a high discharge capacity was obtained.

Incidentally, the larger the carbon number of the main chain of the saturated hydrocarbon group, the higher the effect as the surfactant is. However, when the carbon number of the main chain of the saturated hydrocarbon group is 20 or more as in Compounds G and H, since the relative concentration of the halogenated silyl group is lowered, there was a tendency that the effect for suppressing the blister at the time of high-temperature storage becomes slightly weak.

On the other hand, in the case of using an electrolytic solution containing the silylalkyl halide compound having a saturated hydrocarbon group having a main chain with a carbon number of not more than 7 as in Compounds L to P, the effect as the surfactant was small, so that a high discharge capacity was hardly obtainable.

Also, in the silylalkyl halide compound having a halogen on the silicon atom as in Compounds A to K, it may be considered that a stiff coating with high reactivity at the time of initial charge can be formed, and therefore, the effect for suppressing the blister at the time of high-temperature storage was large.

On the other hand, in the case of using an electrolytic solution containing the silylalkyl halide compound not having a halogen on the silicon atom as in Compounds Q to R, the effect for suppressing the blister at the time of high-temperature storage was small.

Though Compounds S, T and U have a surface active effect, they are low in the reactivity at the time of initial charge/discharge so that it may be impossible to form a coating. Therefore, in the case of using an electrolytic solution containing such a compound, it was difficult to suppress the blister at the time of high-temperature storage and the rise of the resistance value.

### 6. Other Embodiments

It should not be construed that the present disclosure is limited to the foregoing embodiments according to the present disclosure, and various modifications and applications can be made therein so far as the gist of the present disclosure is not deviated.

For example, in the foregoing embodiments and working examples, the batteries having a laminated film type or cylindrical type battery structure, the batteries having a wound structure in which the electrodes are wound and the batteries of a stack type having a structure in which the electrodes are stacked have been described, but it should not be construed that the present disclosure are limited thereto. For example, the present disclosure can be similarly applied to batteries having other battery structure such as a rectangular type, a coin type and a button type and batteries provided with a battery element in which a positive electrode and a negative electrode are laminated and folded in a zigzag form, and the same effects can be obtained. Also, the present disclosure is applicable to the case of using other alkali metal such as sodium (Na) and potassium (K), an alkaline earth metal such as magnesium (Mg) and calcium (Ca), or other light metal such as aluminum, and the same effects can be obtained. Also, a lithium metal may be used as the negative electrode active material. The present disclosure can be applied to not only batteries accompanied by a chemical reaction but other electrochemical devices using an electrolytic solution, such as electrical double layer capacitors.

It should be understood that various changes and modifications to the presently preferred embodiments described herein will be apparent to those skilled in the art. Such changes and modifications can be made without departing from the spirit and scope and without diminishing its intended advantages. It is therefore intended that such changes and modifications be covered by the appended claims.

The application is claimed as follows:

1. A nonaqueous electrolyte battery comprising:
a positive electrode;
a negative electrode; and
a nonaqueous electrolyte containing a solvent and an electrolyte salt, wherein
the nonaqueous electrolyte contains a silyl compound represented by the following formula (1) 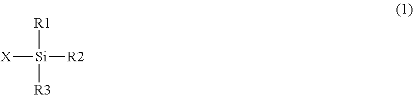
wherein
X represents an aliphatic hydrocarbon group having a main chain with a carbon number of 8 or more and not more than 22;
a part or all of hydrogens of X may be substituted with a halogen;
each of R1 to R3 independently represents a hydrogen group, a halogen group or an aliphatic hydrocarbon group; and
at least one of R1 to R3 contains a halogen group.

2. The nonaqueous electrolyte battery according to claim 1, wherein a content of the silyl compound is 0.01% by mass or more and not more than 1% by mass relative to the nonaqueous electrolyte.

3. The nonaqueous electrolyte battery according to claim 1, wherein in the formula (1), X represents an aliphatic hydrocarbon group having a main chain with a carbon number of 8 or more and not more than 20.

4. The nonaqueous electrolyte battery according to claim 1, wherein in the formula (1), the aliphatic hydrocarbon group is an alkyl group.

5. The nonaqueous electrolyte battery according to claim 1, wherein in the formula (1), two or more of R1 to R3 are a halogen group.

6. The nonaqueous electrolyte battery according to claim 1, wherein in the formula (1), the halogen group is a chlorine group or a fluorine group.

7. The nonaqueous electrolyte battery according to claim 1, packaged by a laminated film.

8. A nonaqueous electrolyte comprising:
a solvent;
an electrolyte salt; and
a silyl compound represented by the following formula (1) 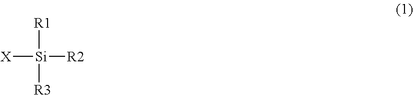
wherein
X represents an aliphatic hydrocarbon group having a main chain with a carbon number of 8 or more and not more than 22;
a part or all of hydrogens of X may be substituted with a halogen;
each of R1 to R3 independently represents a hydrogen group, a halogen group or an aliphatic hydrocarbon group; and
at least one of R1 to R3 contains a halogen group.
